(19) United States
(12) Patent Application Publication
(10) Pub. No.: US 2003/0095482 A1
(43) Pub. Date: May 22, 2003

(54) Method for adjusting the writing speed of a CD drive

(76) Inventors: Chien-Li Hung, Hsinchu (TW); Chi-Yuan Liu, Hsinchu (TW)

Correspondence Address: Raymond Sun, 12420 Woodhall Way, Tustin, CA, 92782, US

(21) Appl. No.: 10/131,746

(22) Filed: Apr. 24, 2002

(30) Foreign Application Priority Data
Nov. 20, 2001 (TW) 90128704

(51) Int. Cl. G11B 7/00

(52) U.S. Cl. 369/47.44; 369/53.22; 369/53.37

(57) ABSTRACT

A method of adjusting the write speed of a CD drive includes writing data from a CD drive to a disk at a first speed. Then, if the absolute time in pregroove (ATIP) error rate of the compact disk at the first speed is larger than a corresponding first preset error allowance upper limit for the first speed, then the first speed is reduced. On the other hand, if the ATIP error rate of the compact disk at the first speed is smaller than the first preset error allowance upper limit, then data continues to be written from the CD drive to the disk at the same first speed. Thus, write failures can be avoided and the quality of the written data can be improved.

### BACKGROUND OF THE INVENTION

1. Field of the Invention

The present invention relates to a method for dynamically adjusting the writing speed of a compact disk (CD-RW) drive.

2. Description of the Prior Art The current writing speed of laser compact disks that may be written (i.e., recorded or burned) once (CD-R) in CD-RW drives that are available on the market has reached 24×, and a continued increase in the writing speed in the future is expected. However, the compact disks made by different manufacturers do not have completely identical features, so that the data writing conditions can also be different at the same write speeds. At a given data write speed, it is possible that the compact disk of one brand is able to completely and correctly carry out the data writing action, while the compact disk of another brand may experience problems. For example, data may be omitted, or read outs may be impossible even though the writing is completed, among other unexpected situations.

When a compact disk is made in a factory, a helical pregroove is carved onto its surface. The helical pregroove (also referred to herein as “groove”) covers the whole disk from an inside circle radiating outwardly at an interval of about 1.6 micrometers. Taking a 12 cm disk as an example, the groove will cover the whole disk with about 20,000 circles. An optical head is guided by means of this groove to radiate a laser beam on to the groove with the result that a sequence of pits and lands of different patterns are formed, with the patterns of the pits and lands obtained in accordance with codes of the data to be written. The groove is carved with some slight wobbles, by which the whole groove is etched in continuous time. FIG. 1 is a localized schematic diagram of one of the wobble grooves 22 etched into a compact disk. In FIG. 1, the maximum degree of wobble of a wobble groove 22 is 30 nanometers in the deviation of its actual center from the average center. By analyzing the above-mentioned wobble groove 22, the absolute time in pregroove (ATIP) of the compact disk can be obtained. ATIP is well-known in the art, and essentially provides information about the minute, second and frame being accessed or written. In other words, ATIP functions like an addressing means.

FIG. 2 is a schematic diagram of one example of a coded program 30 of the ATIP on the compact disk 38. The coded program 30 of the ATIP includes a frequency source 32 (e.g., of 44.1 kHz), and the signal from the frequency source 32 of 44.1 kHz becomes the frequency carrying signal with a frequency of 22.05 kHz after it passes through a 2× divider 34. This frequency carrying signal is provided to an frequency modulator 37. In addition, the signal from the frequency source 32 passes through a 7× divider 35 to form a signal of a biphase clock with a frequency of 6.3 kHz, which is provided to a biphase modulator 36. The ATIP data 31 first passes through the biphase modulator 36, and then passes through the frequency modulator 37 at a carrier frequency of 22.05 kHz, and is finally etched onto the compact disk 38.

FIG. 3 is a schematic diagram of one example of a code format 40 of the ATIP on the compact disk 38. The code format 40 of the ATIP can include a 4 bit parity 42, a minute data 44 of 8 bits, a second data 46 of 8 bits, a frame data 47 of 8 bits, and a correction code 48 of 14 bits. Correction code 48 functions as an error detection code.

Using the obtained ATIP, it is possible to determine (i) the starting point for the time when the writing operation is carried out, and (ii) the ending point for the time available for the writing. For example, a location that is about 25 mm from the axis of the compact disk is approximately the zero point of the ATIP of the compact disk (i.e., 00 min, 00 sec, 00 frame). The total duration of the ATIP is the total writable time of the compact disk that can generally be seen on the compact disk. However, this duration changes along with the linear velocity of the compact disk when the compact disk is spinning. As an example, when the linear velocity of a compact disk is 1.2 m/sec, the total time available for writing on this compact disk is about 74 min. When the linear velocity of the compact disk is increased to 1.4 m/sec, the total time available for writing on this compact disk is reduced to only about 64 min.

The ATIP not only provides information such as the starting point of data writing, the ending point of data writing, and the like, ATIP can also be used to control the spinning speed of the spindle motor in the CD-RW drive. After wobble signals (which are caused by the wobbles reflecting a laser beam) are decoded for the CD-RW drive, the precise position of the optical head can be located. At the same time, the number of frames that are miscoded within a certain time period are estimated, and this is referred to as the misdecoded ATIP error rate (“ATIP error rate”). In the case when a disk is of poor quality and cannot support writing at a higher speed, the ATIP error rate will be increased during the writing process of a CD-RW drive, which indirectly causes the spinning speed of the motor to destabilize, resulting in incorrect data writing. However, the ATIP does not provide certain relevant information. For example, ATIP does not provide information about the optimum writing speed needed by the compact disk to correctly and completely write data, and whether or not the data can be correctly read after the writing process is completed. As a result, when the CD-RW drive is carrying out the data writing process, it must rely completely on the writing speed specified by the user. This can result in failure of the entire writing process and the subsequent waste of compact disks. For example, if a user selects a speed of 24× for writing to a disk, but the disk is a 16× disk, the writing operation may fail, or the quality of the written data may be poor. This is because the 16× disk cannot support a writing speed of 24×.

FIG. 4 is a flow chart that illustrates the conventional process 10 of writing a compact disk, which includes the following steps. In step 11, the writing of data from the CD or CD-RW drive to a disk begins. In step 12, the ATIP error rate at a certain writing speed is estimated and then compared to a preset error allowance upper limit, and if the ATIP error rate is larger than the preset error allowance upper limit, the writing operation may fail (step 13). This write failure can result because the writing speed is typically not adjusted by the CD drive. On the other hand, if the ATIP error rate is smaller than the error allowance upper limit, then the operation would likely continue at the existing writing speed, as shown in step 14. In step 14, the writing operation is continued at the existing speed until another preset time for a change in the writing speed. In other words, after step 14 has been completed, at intervals of a certain preset time, the ATIP error rate at that time is compared to the error allowance upper limit, which is to say that step 12 is repeated periodically. However, once the ATIP error rate becomes larger than the preset error allowance upper limit, the writing speed of the disk is not adjusted which may result in a write failure. If the ATIP error rate is smaller than the error allowance upper limit, then the writing operation will eventually be completed.

Thus, there still remains a need for a method for adjusting the writing speed of a CD drive to minimize write failures and to improve the quality of the written data.

### SUMMARY OF THE DISCLOSURE

For purposes of the present invention, the term “CD drive” as used herein shall mean and include conventional CD, CD-RW, DVD-RW, DVD+RW, DVD+R drives, as well as all optical recorders.

It is an object of the present invention is to provide a method of adjusting the writing speed of a CD drive to minimize write failures and to improve the quality of the written data.

In order to accomplish the objects of the present invention, the present invention provides a method of adjusting the write speed of a CD drive. According to the method, data is written from a CD drive to a disk at a first speed. Thereafter, if the ATIP error rate of the compact disk at the first speed is larger than a correspondin/g first preset error allowance upper limit for the first speed, then the first speed is reduced. On the other hand, if the ATIP error rate of the compact disk at the first speed is smaller than the first preset error allowance upper limit, then data continues to be written from the CD drive to the disk at the same (e.g., first) speed. Thus, write failures can be avoided and the quality of the written data can be improved.

### BRIEF DESCRIPTION OF THE DRAWINGS

FIG. 1 is a localized schematic diagram of a conventional wobble groove etched into a compact disk.

FIG. 2 is a schematic diagram of one example of a conventional coded program of the ATIP on a compact disk.

FIG. 3 is a schematic diagram of one example of a conventional code format of the ATIP on a compact disk.

FIG. 4 is a flow chart illustrating a conventional writing operation for a conventional CD drive.

FIG. 5 is a graph illustrating an ideal situation of the relationship between the change in writing speed of a compact disk in relation to the absolute time in pregroove (ATIP).

FIG. 6 is a graph illustrating an ideal situation of the relationship between the ATIP error rate in relation to the ATIP of a compact disk.

FIG. 7 is a flow chart illustrating a method according to one embodiment of the present invention.

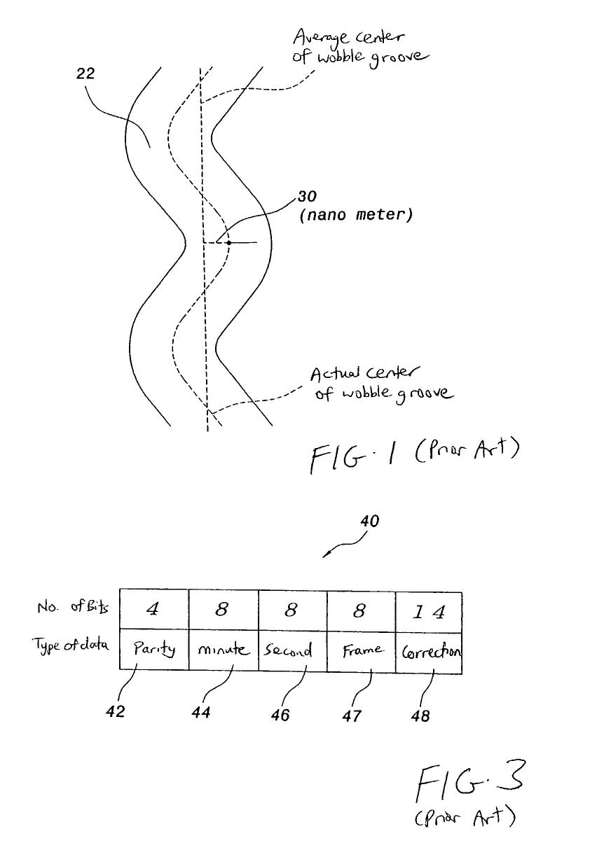

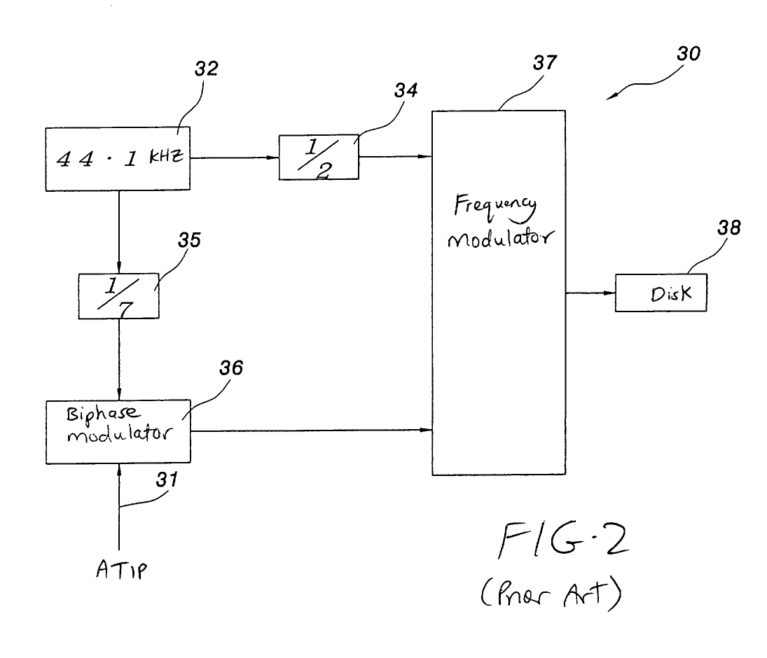

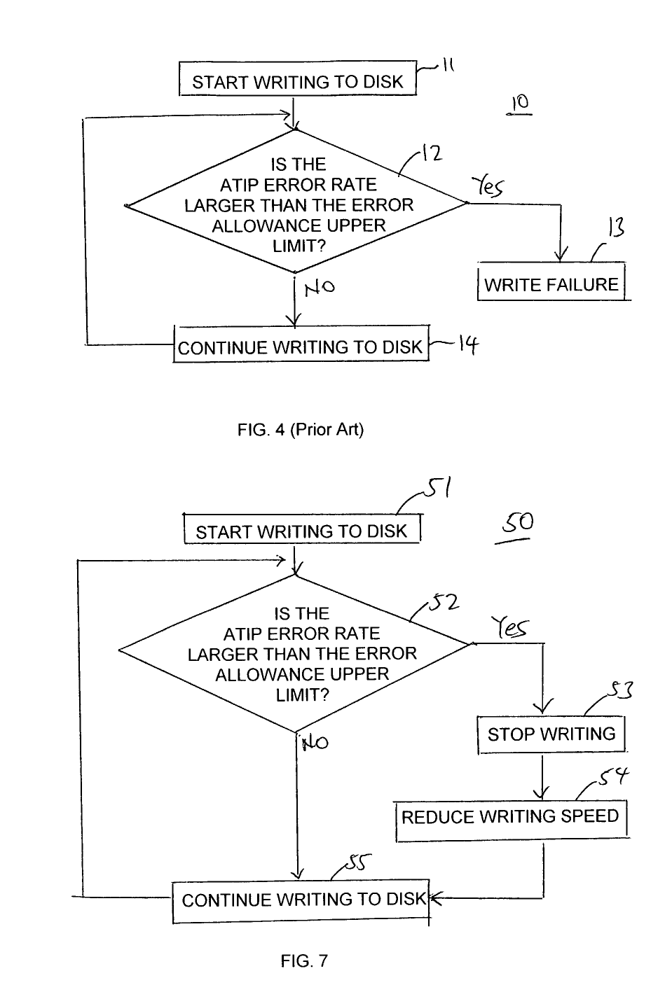

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention provides a method for dynamically adjusting the writing speed of a CD drive when writing data to a compact disk. The writing speed of a CD drive is adjusted in accordance with the result of a comparison between a preset error allowance upper limit and the ATIP error rate. When the ATIP error rate is larger than the preset error allowance upper limit, the writing speed of the CD drive is adjusted to a lower level (i.e., reduced) so that undesirable writing results (such as loss of data to be written, or inability to read out data from the disk even though the writing was completed without a write failure) are minimized, and the subsequent waste of compact disks is kept to a minimum. On the other hand, if the ATIP error rate is smaller than the error allowance upper limit, then the CD drive continues to write data at the existing writing speed until a change in the writing speed is necessitated (if at all) at another preset time.

The ATIP error rate of the compact disk while it is being written on is obtained by calculating the number of errors in decoding the ATIP frame in unit time. FIG. 5 is a schematic diagram illustrating the change in writing speed of a conventional compact disk in relation to the ATIP. In FIG. 5, before the ATIP T1, the CD drive writes data at a certain linear velocity, and after passing the point of T1 in time, the CD drive will shift to a higher speed for writing. Similar shifts in writing speed also occur at the points in time T2 and T3. In this regard, the writing speed must necessarily increase when writing to the outer area of the compact disk (i.e., the higher ATIPs) because the outer circles of the groove are larger than the circles closer to the center of the compact disk.

FIG. 6 is a schematic diagram of the relationship between the ATIP error rate and the ATIP of the compact disk. FIG. 6 depicts an ideal situation for the sake of simplicity, because in practice, the change in the ATIP error rate of the compact disk in relation to the change in the ATIP of the compact disk will differ because of the variation in the quality of the compact disk and the decoding ability of the CD drive. In general, as shown in FIG. 6., an increase in the ATIP will bring along with it a corresponding increase in the ATIP error rate of the compact disk. Because an error allowance upper limit can be preset in advance by the designer of the CD drive, the error allowance upper limit must also be adjusted upwardly in a corresponding manner in relation to the increase in the ATIP (as the writing speeds are being increased), so that the error allowance upper limit keeps pace with the ATIP error rate that is expected to be increased along with the increase in writing speed.

Consider, for example, a compact disk whose total time available for writing is 74 minutes. Such a compact disk would have a total of 74 minutes×60 seconds×75 frames. During the writing operation, the laser beam follows the wobble pre-groove to write the data (i.e., form the wobble signal) with an ATIP frame information which is embodied in the form shown in FIG. 3. If the parity of 14 bits in the correction code 48 is incorrect, then this particular frame would be in error. The ATIP error rate can then be defined as the total number of error frames per second.

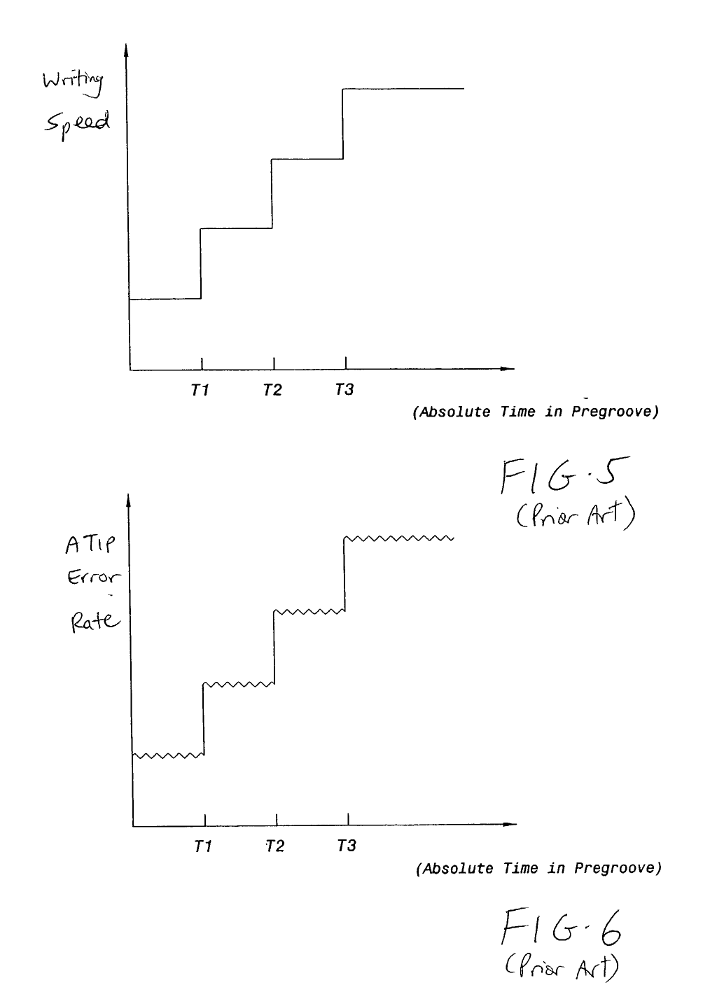

FIG. 7 is a flow chart of a method 50 for dynamically adjusting the writing speed of a CD drive according to one embodiment of the present invention. The method 50 has the following steps:

Step 51: The CD drive starts writing at a given (e.g., first) speed. Processing then proceeds to step 52.

Step 52: In this step, a comparison is carried out to see whether or not the ATIP error rate of the compact disk at the existing (e.g., first) writing speed is larger than the error allowance upper limit that has been preset or selected for this speed.

This comparison is carried out on a continuous (i.e., real-time) basis. If the ATIP error rate of the compact disk at the present writing speed is larger than the preset error allowance upper limit for that speed, then processing proceeds to step 53, otherwise processing proceeds to step 55.

Step 53: In this step, the writing operation is temporarily stopped and processing then proceeds to step 54.

Step 54: In this step, the writing speed is reduced to a lower (e.g., second) speed. There are a number of ways of reducing the writing speed. For example, one method might involve having the controller of the CD drive dynamically calculate (on a real-time basis) the most desirable next lower speed. A more common method would be to preset a number of progressive writing speeds, such as 8×, 12×, 16×, 24×, 32×, 40× and 48× (in that order) which are writing speeds best suited for most conventional CD drives. Then, if the current writing speed is, for example 24×, the controller could reduce the writing speed to the next lower writing speed, which would be 16×. If the CD drive is already operating at the lowest writing speed (such as 8×), then no speed reduction is possible so that, in step 55, the CD drive will continue to maintain this lowest writing speed until the entire writing operation is completed. Processing then proceeds to step 55.

Step 55: In this step, the writing operation is continued at the existing writing speed (if operation came from step 52) or at the new reduced writing speed (if operation came from step 54). Processing then returns to step 52 and the writing operation is continued at this speed, or any increased speed which is necessitated by an increase in the ATIP (as explained in greater detail below). In other words, step 52 will again determine if the ATIP error rate of the compact disk at the current writing speed (which can the existing first speed or a reduced speed) is larger than the preset error allowance upper limit for the current writing speed, and then processing proceeds to either step 53 or step 55 depending on the determination.

In step 52, the comparison carried out to see whether or not the ATIP error rate of the compact disk at the present writing speed is larger than the preset error allowance upper limit for that speed can be accomplished through the use of thresholds. As a non-limiting example, assume that a selected threshold for the preset error allowance upper limit is 40% of total error frames per second. Therefore, if a total of 75 frames are written per second, then a 40% threshold would mean 30 erroneous frames. The preset error allowance upper limit does not need to be merely one threshold, but can comprise a combination of comparisons. As a non-limiting example, the preset error allowance upper limit can be deemed to have been met if there are three consecutive occurrences of a 20% error rate (i.e., in other words, x consecutive times where there are y number of erroneous frames).

The preset time mentioned above is the ATIP of the compact disk, and each preset ATIP has a corresponding preset error allowance upper limit and a corresponding preset writing speed. As explained in connection with FIGS. 5 and 6 above, as the writing operation continues (i.e., in step 55), the writing will move from the inner circles of the groove 22 to the outer circles of the groove 22, so that the writing speed (e.g., in step 55) will necessarily increase as well. This gradual increase in the writing speed can occur at any time during the processing of the method illustrated in FIG. 7, as long as the next ATIP is reached. If the ATIP error rate calculated when the compact disk reaches the next (progressively higher) ATIP is smaller than the preset error allowance upper limit, then this corresponding increase in the writing speed can be allowed. However, if the calculated ATIP error rate is larger than the preset error allowance upper limit, then the writing speed at that time can be decreased by the present invention so that further incidents of erroneous data writing can be minimized.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A method of adjusting the write speed of a CD drive, comprising:
a. writing data from a CD drive to a disk at a first speed;
b. determining whether the ATIP error rate of the compact disk at the first speed is larger than a first preset error allowance upper limit that corresponds to the first speed;
c. if the ATIP error rate of the compact disk at the first speed is larger than the first preset error allowance upper limit, then reducing the first speed; and
d. if the ATIP error rate of the compact disk at the first speed is smaller than the first preset error allowance upper limit, then continuing to write data from the CD drive to the disk at the first speed.

2. The method of claim 1, wherein reducing first speed comprises reducing the first speed to a slower second speed, wherein the method further includes:
e. writing data from the CD drive to the disk at the second speed;
f. determining whether the ATIP error rate of the compact disk at the second speed is larger than a second preset error allowance upper limit that corresponds to the second speed;
g. if the ATIP error rate of the compact disk at the second speed is larger than the second preset error allowance upper limit, then reducing the second speed; and
h. if the ATIP error rate of the compact disk at the second speed is smaller than the second preset error allowance upper limit, then continuing to write data from the CD drive to the disk at the second speed.

3. The method claim 1, further including:
pre-setting a plurality of progressive writing speeds that includes the first speed and a second speed that is slower than the first speed, wherein reducing first speed comprises reducing the first speed to the second speed.

4. A method of adjusting the write speed of a CD drive, comprising:
a. writing data from a CD drive to a disk at a first speed;
b. if the ATIP error rate of the compact disk at the first speed is larger than a corresponding first preset error allowance upper limit for the first speed, then reducing the first speed; and
c. if the ATIP error rate of the compact disk at the first speed is smaller than the first preset error allowance upper limit, then continuing to write data from the CD drive to the disk at the first speed.

5. The method of claim 4, wherein reducing first speed comprises reducing the first speed to a slower second speed, wherein the method further includes:
d. writing data from the CD drive to the disk at the second speed;
e. if the ATIP error rate of the compact disk at the second speed is larger than a corresponding second preset error allowance upper limit, then reducing the second speed; and
f. if the ATIP error rate of the compact disk at the second speed is smaller than the second preset error allowance upper limit, then continuing to write data from the CD drive to the disk at the second speed.

6. The method claim 4, further including:
pre-setting a plurality of progressive writing speeds that includes the first speed and a second speed that is slower than the first speed, wherein reducing first speed comprises reducing the first speed to the second speed.

7. A method of adjusting the write speed of a CD drive, comprising:
a. writing data from a CD drive to a disk at a first speed;
b. reducing the first speed to a second slower speed if the ATIP error rate of the compact disk at the first speed is larger than a corresponding first preset error allowance upper limit for the first speed; and
c. reducing the second speed to a third slower speed if the ATIP error rate of the compact disk at the second speed is larger than a corresponding second preset error allowance upper limit for the second speed.

8. The method of claim 7, further including:
d. reducing the third speed if the ATIP error rate of the compact disk at the third speed is larger than a corresponding third preset error allowance upper limit for the third speed.
